(19) United States
(12) Patent Application Publication
(10) Pub. No.: US 2018/0285906 A1
(43) Pub. Date: Oct. 4, 2018

(54) AUTOMATICALLY PRIORITIZING SALES LEADS FOR EDUCATIONAL TECHNOLOGY PRODUCTS

(71) Applicant: LinkedIn Corporation, Sunnyvale, CA (US)

(72) Inventors: Ming M. Ng, Santa Barbara, CA (US); Zhaoying Han, Mountain View, CA (US); Sandeep Rohilla, Belmont, CA (US); Coleman Patrick King, III, Brooklyn, NY (US); Tony Yin, Millbrae, CA (US)

(73) Assignee: LinkedIn Corporation, Sunnyvale, CA (US)

(21) Appl. No.: 15/478,029

(22) Filed: Apr. 3, 2017

(51) Int. Cl. G06Q 30/02; G06Q 50/20; G06Q 50/00

(52) U.S. Cl. CPC G06Q 30/0204; G06Q 50/01; G06Q 50/20

(57) ABSTRACT

The disclosed embodiments provide a system for processing data. During operation, the system obtains a set of features associated with a sales lead for an educational technology product, wherein the set of features includes profile data from an online professional network. Next, the system uses the set of features to generate a set of quality indicators for the sales lead. The system then aggregates the quality indicators into a lead score representing a quality of the sales lead. Finally, the system outputs the lead score for use in managing sales activity with the sales lead.

### Related Applications

The subject matter of this application is related to the subject matter in a co-pending non-provisional application by inventors Zhaoying Han, Patrick King, Yiying Cheng and Julie Wang, entitled “Evaluating and Comparing Predicted Customer Purchase Behavior for Educational Technology Products,” having Ser. No. 15/195,870, and filing date 28 Jun. 2016 (Attorney Docket No. LI-P2017.LNK.US).

The subject matter of this application is also related to the subject matter in a co-pending non-provisional application by inventors Zhaoying Han, Yiying Cheng, Julie Wang and Wenjing Zhang, entitled “Evaluating Potential Spending for Customers of Educational Technology Products,” having serial number TO BE ASSIGNED, and filing date TO BE ASSIGNED (Attorney Docket No. LI-P2265.LNK.US).

### BACKGROUND

### Field

The disclosed embodiments relate to techniques for managing sales activities. More specifically, the disclosed embodiments relate to techniques for automatically prioritizing sales leads for educational technology products.

### Related Art

Social networks may include nodes representing entities such as individuals and/or organizations, along with links between pairs of nodes that represent different types and/or levels of social familiarity between the nodes. For example, two nodes in a social network may be connected as friends, acquaintances, family members, and/or professional contacts. Social networks may further be tracked and/or maintained on web-based social networking services, such as online professional networks that allow the entities to establish and maintain professional connections, list work and community experience, endorse and/or recommend one another, run advertising and marketing campaigns, promote products and/or services, and/or search and apply for jobs.

In turn, social networks and/or online professional networks may facilitate sales and marketing activities and operations by the entities within the networks. For example, sales professionals may use an online professional network to identify prospective customers, maintain professional images, establish and maintain relationships, and/or close sales deals. Moreover, the sales professionals may produce higher customer retention, revenue, and/or sales growth by leveraging social networking features during sales activities. For example, a sales representative may improve customer retention by tailoring his/her interaction with a customer to the customer's behavior, priorities, needs, and/or market segment, as identified based on the customer's activity and profile on an online professional network.

Consequently, the performance of sales professionals may be improved by using social network data to develop and implement sales strategies.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating the processing of data in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

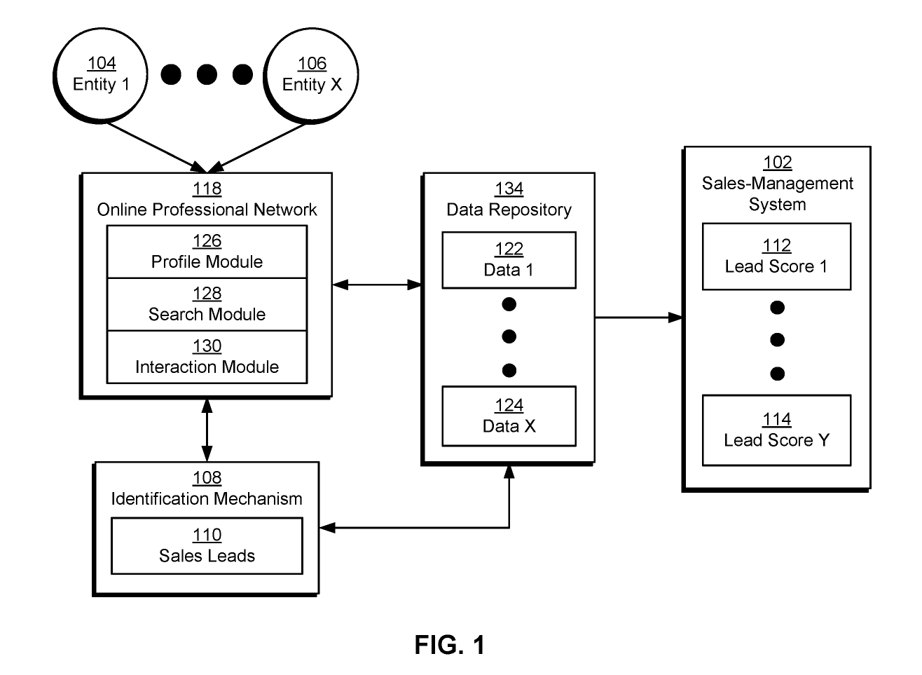

The disclosed embodiments provide a method, apparatus, and system for processing data. More specifically, the disclosed embodiments provide a method, apparatus, and system for automatically prioritizing sales leads for educational technology products. As shown in FIG. 1, a set of potential sales leads 110 may be members of a social network, such as an online professional network 118 that allows a set of entities (e.g., entity 1 104, entity x 106) to interact with one another in a professional and/or business context.

The entities may include users that use online professional network 118 to establish and maintain professional connections, list work and community experience, endorse and/or recommend one another, and/or search and apply for jobs. The entities may also include companies, employers, and/or recruiters that use the online professional network to list jobs, search for potential candidates, and/or provide business-related updates to users.

The entities may use a profile module 126 in online professional network 118 to create and edit profiles that may contain profile pictures, along with information related to the entities' professional and/or industry backgrounds, experiences, summaries, projects, and/or skills. The profile module may also allow the entities to view the profiles of other entities in the online professional network.

Next, the entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on the online professional network to search for profiles, jobs, and/or information by categories such as first name, last name, title, company, school, location, interests, relationship, industry, groups, salary, and/or experience level.

The entities may also use an interaction module 130 to interact with other entities on online professional network 118. For example, the interaction module may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, the online professional network may include a homepage, landing page, and/or newsfeed that provides the latest postings, articles, and/or updates from the entities' connections and/or groups to the entities. Similarly, the online professional network may include mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in the online professional network may be tracked and stored in a database, data warehouse, cloud storage, and/or other data-storage mechanism providing the data repository.

The entities may also include a set of customers that purchase products through online professional network 118. For example, the customers may include individuals and/or organizations with profiles on the online professional network and/or sales accounts with sales professionals that operate through the online professional network. As a result, the customers may use the online professional network to interact with professional connections, list and apply for jobs, establish professional brands, purchase or use products offered through the online professional network, and/or conduct other activities in a professional and/or business context.

The customers may also be targeted for marketing or sales activities by other entities in online professional network 118. For example, the customers may be companies that purchase business products and/or solutions that are offered by the online professional network to achieve goals related to hiring, marketing, advertising, selling, and/or e-learning. In another example, the customers may be individuals and/or companies that are targeted by marketing and/or sales professionals through the online professional network.

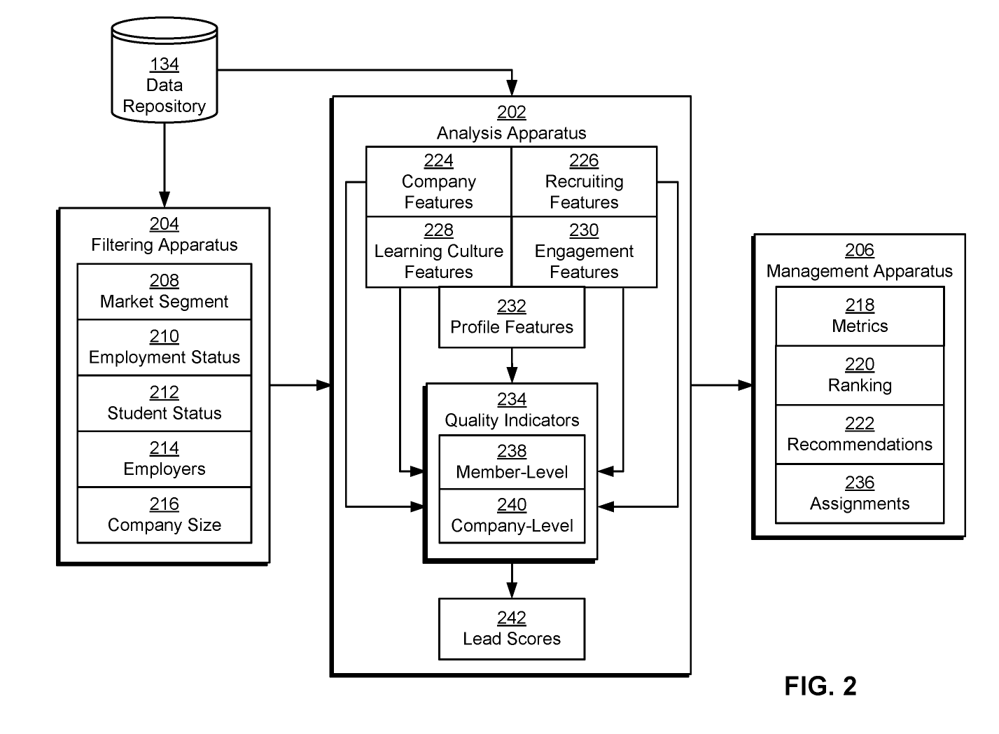

To drive sales and/or marketing activities through online professional network 118, an identification mechanism 108 may identify a set of sales leads 110 for the products using data from data repository 134 and/or online professional network 118. For example, identification mechanism 108 may identify the sales leads by matching profile data, group memberships, industries, skills, customer relationship data, and/or other data associated with members of the online professional network to keywords related to products that may be of interest to the members. In another example, the identification mechanism may apply a set of filters to some or all members of the online professional network to obtain a subset of the members as the sales leads, as described in further detail below with respect to FIG. 2. In a third example, the identification mechanism may identify the sales leads as individuals associated with sales accounts with the online professional network and/or products offered by or through the online professional network.

Identification mechanism 108 may also match sales leads 110 to products using different sets of criteria. For example, the identification mechanism may match members in recruiting roles to recruiting solutions, members in sales roles to sales solutions, members in marketing roles to marketing solutions, members in learning and development roles to educational technology products, and members in advertising roles to advertising solutions. If different variations of a solution are available, the identification mechanism may also identify the variation that may be most relevant to the member based on the size, location, industry, and/or other attributes of the member. In another example, products offered by other entities through online professional network 118 may be matched to sales leads through criteria specified by the other entities.

After sales leads 110 are identified, they may be targeted by one or more sales professionals with relevant products. For example, the sales professionals may use newsletters, emails, phone calls, and/or other types of communications to engage with members identified as sales leads with recruiting, marketing, sales, advertising, and/or learning technology solutions that may be of interest to the members. In turn, the sales professionals may pursue further communication and sales potential with the sales leads.

To facilitate prioritization of sales activities with a potentially large number of sales leads 110, a sales-management system 102 may calculate a lead score (e.g., lead score 1 112, lead score y 114) for each sales lead. The lead score may represent a quality of the sales lead with respect to an educational technology product (e.g., e-learning product) and/or other type of product offered by or within online professional network 118. As described in further detail below, the sales-management system may use profile data from the online professional network and/or other features associated with the sales lead to generate a set of quality indicators for the sales lead. The sales-management system may then aggregate the quality indicators into a lead score for the sales lead. In turn, the lead score may be used by sales professionals to prioritize engagement or communication with the sales leads.

FIG. 2 shows a system for processing data in accordance with the disclosed embodiments. More specifically, FIG. 2 shows a system for evaluating the qualification of sales leads (e.g., sales leads 110 of FIG. 1), such as sales-management system 102 of FIG. 1. As shown in FIG. 2, the system includes an analysis apparatus 202, a filtering apparatus 204, and a management apparatus 206. Each of these components is described in further detail below.

Filtering apparatus 204 may identify a set of sales leads for an educational technology product. As mentioned above, each sales lead may be a member of an online professional network (e.g., online professional network 118 of FIG. 1) that is identified using data from data repository 134. To determine if a given member is a sales lead or not, the filtering apparatus may apply a set of filters to profile data for the member from the data repository.

First, filtering apparatus 204 may filter members of the online professional network by a market segment 208. For example, the filtering apparatus may include, in the market segment, members who have requested additional information for the educational technology product, visited a website for the educational technology product, and/or downloaded informational material for the educational technology product. At the same time, the filtering apparatus may remove members who are not in the market segment from a set of potential sales leads for the educational technology product.

Second, filtering apparatus 204 may filter the potential sales leads by employment status 210 and student status 212. For example, the filtering apparatus may use profile data from the online professional network to remove, from the set of potential sales leads identified as members in market segment 208, members who are unemployed and/or students.

Third, filtering apparatus 204 may filter the potential sales leads by employers 214 and company size 216. For example, the filtering apparatus may remove, from the potential sales leads, members that do not specify an employer and/or members who specify small companies (e.g., companies with less than 10 employees) as employers. The filtering apparatus may also remove, from the potential sales leads, members that are employed at competitors of the educational technology product and/or at a company that produces the educational technology product. In general, the filtering apparatus may disqualify members with employers that match any number of attributes (e.g., name, industry, size, location, company type, products made or sold by the company, etc.) from inclusion in the set of potential ales leads.

After all filters have been applied to the set of potential sales leads, filtering apparatus 204 may obtain remaining members who have not been excluded by the filters as sales leads for the educational technology product. For example, the filtering apparatus may generate a set of sales leads for the educational technology product as members of the online professional network who have expressed interest in the educational technology product, who are non-students, and who are employed at companies of a certain minimum size. The filtering apparatus may also supplement the set of sales leads with existing sales leads identified in customer relationship management (CRM) accounts associated with the companies.

Next, analysis apparatus 202 may use a set of features for the sales leads to generate a set of lead scores 242, with each lead score representing a quality or qualification of a corresponding sales lead. The features may include one or more company features 224, one or more recruiting features 226, one or more learning culture features 228, one or more engagement features 230, and/or one or more profile features 232. In some embodiments, one or more of these types of features may be omitted.

Company features 224 may include attributes and/or metrics associated with a company at which the sales lead is employed. For example, the company features may include demographic attributes such as a location, an industry, an age, and/or a size (e.g., small business, medium/enterprise, global/large, number of employees, etc.) of the company.

Company features 224 may also relate to the size and/or composition of the company. For example, the company features may include a number of employees, a number of employees who are members of the online professional network, a number of employees at a certain level of seniority (e.g., entry level, mid-level, manager level, senior level, etc.) who are members of the online professional network, and/or a number of employees with certain roles (e.g., accounting, design, education, finance, engineering, product management, project management, operations, business development, sales, marketing, executive, etc.) or groups of roles who are members of the online professional network. In turn, the metrics may be used to estimate the size of the company and/or the distribution of roles in the company. The company features may further include a measure of dispersion in the company, such as a number of unique regions (e.g., metropolitan areas, counties, cities, states, countries, etc.) to which the employees and/or members of the online professional network from the company belong.

Company features 224 may additionally include metrics related to key market segments for consuming educational technology products, such as information technology (IT) professionals, software developers, data scientists, creative roles (e.g., designers, artistic directors, artists, etc.), managers, and/or decision makers (e.g., vice presidents, directors, executives, owners, etc.). These metrics may include, for example, the number of employees and/or online professional network members at the company in each market segment and/or the number of employees and/or online professional network members that belong only to a single market segment. Generally, key market segments may include users or roles that are related or relevant to educational content, tools, or features provided with the educational technology product.

Recruiting features 226 may identify recruiting activity of the company. For example, recruiting features 226 may include the number of recruiters, talent professionals (e.g., human resources staff), hiring months out of a calendar year, and/or hires in the last year by the company. The recruiting features may also include a spending of the company with a recruiting solution or product offered by or through the online professional network.

Learning culture features 228 may characterize the level of learning culture at the company. For example, the learning culture features may describe the connectedness of the company with e-learning companies using metrics such as the number of online professional network connections between employees of the company and e-learning companies, the same number of connections divided by the total number of online professional network members at the company, the number of connections between the company's employees and e-learning sales professionals, and/or the number of sales professionals at the company with connections to e-learning companies. The learning culture features may also include the number of people at the company who follow an e-learning company (e.g., in the online professional network), the same number of followers divided by the total number of online professional network members at the company, the number of company employees with e-learning certificates, and/or the same number of employees divided by the total number of employees and/or online professional network members at the company. The learning culture features may further identify the presence or absence of learning decision makers at the company (e.g., people with online professional network profiles related to learning or development), the number of learning decision makers at the company, and/or whether a learning decision maker has recently joined the company (e.g., in the last six months). Finally, the learning culture features may identify the number of online professional network members at the company with skills listed in their profiles and/or the same number of members divided by the total number of online professional network members at the company.

Engagement features 230 may represent the company's level of engagement with and/or presence on the online professional network. For example, the engagement features may include the number of members of the online professional network who work at the company, the number of online professional network members at the company with connections to employees of the online professional network, the number of connections among employees in the company, and/or the number of followers of the company in the online professional network. The engagement features may also track visits to the online professional network from employees of the company, such as the number of employees at the company who have visited the online professional network over a recent period (e.g., the last 30 days) and/or the same number of visitors divided by the total number of online professional network members at the company.

Engagement features 230 may also include the company's engagement with products offered by or through the online professional network. For example, the engagement features may include a social selling index (SSI) score that measures the level of sales activity at the company, an interest score that estimates the company's likelihood of purchasing another product offered through the online professional network (e.g., recruiting solution, sales solution, marketing solution, advertising solution, etc.), the company's spending with the other product, the company's level of activity or success with the other product (e.g., a number of hires impacted by a recruiting solution in the last 12 months), and/or the company's status as a customer or non-customer with the other product.

Profile features 232 may be obtained from profile data for the sales lead. For example, the profile features may include the title, industry, summary, occupation, work experience, skills, seniority, decision maker score, employer, location, groups, contact information, email domain, profile completeness, and/or other profile attributes of the sales lead.

After company features 224, recruiting features 226, learning culture features 228, engagement features 230, and profile feature 232 are obtained from data repository 134, analysis apparatus 202 may modify some or all of the features. First, the analysis apparatus may apply imputations that add default values, such as zero numeric values or median values, to features with missing values. Second, the analysis apparatus may “bucketize” numeric values for some features (e.g., number of employees) into ranges of values and/or a smaller set of possible values. Third, the analysis apparatus may apply, to one or more subsets of features, a log transformation that reduces skew in numeric values and/or a binary transformation that converts zero and positive numeric values to respective Boolean values of zero and one. Fourth, the analysis apparatus may normalize scores to be within a range (e.g., between 0 and 10), verify that feature ratios are within the range of 0 and 1, and perform other transformations of the features. In general, such preprocessing and/or modification of features by the analysis apparatus may be performed and/or adapted based on configuration files and/or a central feature list.

Next, analysis apparatus 202 may use the features to generate a set of quality indicators 234 for each sales lead. Each quality indicator may include a numeric value that represents a component of the quality or qualification of the sales lead, with a higher value reflecting a greater contribution of the component to the quality or qualification. Quality indicators 234 may be divided into member-level 238 indicators that are related to the sales lead and company-level 240 indicators that are related to the company at which the sales lead is employed.

Member-level 238 indicators may include a learning and development indicator that represents the likelihood of the sales lead in occupying a learning and development role. For example, the learning and development indicator may be a Boolean value that is set to 1 when the sales lead is identified as a learning and development professional and 0 when the sales lead is identified to not be a learning and development professional. Alternatively, the learning and development indicator may include a range of values that indicate the confidence in the sales lead occupying a learning and development role.

The learning and development indicator may be produced using profile features 232 such as a title and/or occupation of the sales lead. For example, the learning and development indicator may identify the sales lead as a learning and development professional when the title and/or occupation of the sales lead include keywords such as “learning,” “career,” “training,” “trainer,” “development,” “e-learning,” “instruction,” and/or “education.”

Member-level 238 indicators may also include a prospect score that is used to evaluate the suitability of the sales lead as a sales prospect. For example, the prospect score may be calculated from one or more rankings of profile features 232 such as title and seniority. Using such features, members may initially be categorized as professionals related to learning and development (e.g., using the learning and development indicator), human resources, information technology, and/or other types of roles. The members may then be ranked by the identified role types, such that learning and development roles are ranked first, human resources roles are ranked second, information technology roles are ranked third, and “other” roles are ranked last. In turn, a member's position in a ranking or sub-ranking may be used to determine the member's prospect score, such that a member with a higher position in the ranking has an equal or higher score than a member with a lower position in the ranking. Thus, members in learning and development roles may have higher prospect scores than members in human resources roles, members in human resources roles may have higher prospect scores than members in information technology roles, and members in information technology roles may have higher prospect scores than members in “other” roles. The members may additionally be ranked by seniority within a given role type (e.g., a chief learning officer is ranked higher than a career training counselor within the learning and development role type) and/or across role types (e.g., a vice president of human resources is ranked higher than an information technology analyst). The subsequent seniority-based ranking may be used to further modulate the prospect scores within each role type (e.g., so that a member with a higher seniority in the role type has a higher prospect score than a member with a lower seniority in the same role type) and across role types (e.g., so that some members with high seniority in a lower ranked role type have higher prospect scores than members with low seniority in a higher ranked role type).

Member-level 238 indicators may further include an email domain indicator that is calculated as a score that is mapped to the email domain or type of email domain of the sales lead, as listed in profile data for the sales lead. For example, the email domain indicator may be set to a higher value when the email domain indicates that the email address listed in profile data for the sales lead is a corporate email address and a lower value when the email domain indicates that the listed email address is a personal email address.

Finally, member-level 238 indicators may include a contact information indicator that reflects a completeness of contact information for the sales lead. For example, the contact information indicator may be a score, percentage, or other metric that is set to a high value when all fields in a set of contact information for the sales lead are filled in and to a lower value when one or more fields in the contact information (e.g., first name, last name, email address, etc.) are null.

Like member-level 238 indicators, company-level 240 indicators may include a learning and development indicator that represents the likelihood that the company is a learning and development company. For example, the learning and development indicator may be a score, percentage, or other metric that is calculated based on the number of learning and development professionals working for the company, the name of the company, the industry of the company, and/or other company features 224. The learning and development indicator may be calculated as a weighted combination of company features 224, inputting company features 224 into a statistical model, and/or applying a formula to company features 224.

Like member-level 238 indicators, company-level 240 indicators may also include a customer ranking that represents the likelihood of the company to become a customer of the educational technology product. For example, customers that are companies may be assigned to “tiers” indicating the likelihood of purchasing the educational technology product as very high, high, medium, low. Each tier may include a pre-specified number of customers and/or a variable number of customers with “likelihood scores” that adhere to one or more thresholds associated with the tier. The likelihood scores for each company may be calculated using features or metrics such as the number of employees at the company who have visited the online professional network more than once over a recent period (e.g., the last 30 days), the percentage of learning and development professionals employed at the company (e.g., as determined using the learning and development indicator for each employee of the company), the percentage of “career builder” professionals employed at the company, the pending of the company with a recruiting solution or product offered by or through the online professional network, and/or the level of activity of certain roles (e.g., learning and development, human resources, etc.) in the company with the online professional network (e.g., measured as the number of visits in a given period). The company may be ranked or scored separately for each feature, and the rankings or scores for all features may be combined (e.g., using a set of weights, a statistical model, and/or a formula) into an overall rank or score for the company. The overall rank or score may then be used to assign the company into a given tier representing the company's likelihood of purchasing the educational technology product.

Company-level 240 indicators may further include a potential spending of the company with the educational technology product. The potential spending may be calculated by inputting one or more company features 224, recruiting features 226, and/or learning culture features 228 into a statistical model and obtaining a prediction of the number of licenses of the educational technology product that the company will purchase. A pricing tier for the company may then be applied to the predicted number of licenses to obtain a dollar value representing the company's potential spending. Calculating potential spending for educational technology products is discussed in a co-pending non-provisional application by inventors Zhaoying Han, Yiying Cheng, Julie Wang and Wenjing Zhang, entitled “Evaluating Potential Spending for Customers of Educational Technology Products,” having serial number TO BE ASSIGNED, and filing date TO BE ASSIGNED (Attorney Docket No. LI-P2265.LNK.US), which is incorporated herein by reference.

Finally, company-level 240 indicators may include a predicted purchase behavior of the company. The predicted purchase behavior may include an overall score representing the company's likelihood of purchasing the educational technology product, as well as a set of sub-scores that characterize different components of the overall score. The predicted purchase behavior may be calculated by inputting one or more company features 224, learning culture features 228, and engagement features 230 into a number of statistical models and obtaining the overall score and sub-scores as output from the statistical models. Predicting customer purchase behavior for educational technology products is described in a co-pending non-provisional application by inventors Zhaoying Han, Patrick King, Yiying Cheng and Julie Wang, entitled “Evaluating and Comparing Predicted Customer Purchase Behavior for Educational Technology Products,” having Ser. No. 15/195,870, and filing date 28 Jun. 2016 (Attorney Docket No. LI-P2017.LNK.US), which is incorporated herein by reference.

Analysis apparatus 202 may aggregate quality indicators 234 for each sales lead into a lead score for the sales lead. For example, the analysis apparatus may normalize the quality indicators so that each quality indicator falls within a certain numeric range (e.g., 0-99). The analysis apparatus may then calculate the lead score as a weighted combination of the quality indicators. Weights in the weighted combination may reflect the relative importance of the corresponding quality indicators in contributing to the lead score. For example, the company-level customer ranking may be assigned a weight of 3, the potential spending may have a weight of 2.5, the member-level prospect score may be assigned a weight of 2, the member-level learning and development indicator may be assigned a weight of 1.5, the company-level learning and development indicator may be assigned a weight of 1, and remaining quality indicators 234 may be assigned the same weight of 0.5. Thus, the customer ranking may contribute six times as much as the three lowest-weighted quality indicators to the lead score. As with the quality indicators, the weighted combination may be normalized to fall within a numeric range (e.g., 0 to 99) to produce a final value for the lead score.

After a set of lead scores 242 is generated for the sales leads, management apparatus 206 may output the lead scores, quality indicators 234, and/or other values associated with the sales leads for use in managing sales activity with the sales leads. First, the management apparatus may display and/or otherwise output a set of metrics 218 associated with the sales leads, such as the lead scores and/or quality indicators. Second, the management apparatus may generate a ranking 220 of the sales leads by the lead scores, quality indicators, and/or other metrics. For example, the management apparatus may rank the sales leads in descending order of lead score and/or one or more metrics. The apparatus may also display the ranking and/or metrics in a chart, table, and/or other representation and enable filtering, sorting, and/or grouping of the displayed data by the metrics or features (e.g., name, title, occupation, industry, company, seniority, etc.) of the sales leads. The management apparatus may further export or store the ranking and/or metrics in a file, database, spreadsheet, and/or other format.

Management apparatus 206 may also generate a set of recommendations 222 associated with the sales leads. For example, the management apparatus may recommend prioritization of sales leads with lead scores 242 that exceed a threshold for a given company, type of company, and/or size of company. The management apparatus may also recommend engaging different subsets of sales leads on different channels (e.g., marketing content, email, phone, etc.) based on the lead scores and/or quality indicators 234 associated with the sales leads.

Second, management apparatus 206 may generate assignments 236 of sales leads to sales and/or marketing professionals, such that sales leads with the highest lead scores are targeted by the most effective sales and/or marketing professionals. The assignments may also be made so that sales leads in different market segments (e.g., industries, sizes, locations, etc.) and/or groups of similar sales leads are assigned to sales and/or marketing professionals with expertise in marketing or selling products to those segments or groups. Consequently, the system of FIG. 2 may improve or automate the use of sales or marketing technology by allowing lead prioritization, lead engagement, and/or other sales or marketing activities to be conducted based on the quality and/or qualification of the sales leads.

Those skilled in the art will appreciate that the system of FIG. 2 may be implemented in a variety of ways. First, analysis apparatus 202, filtering apparatus 204, management apparatus 206, and/or data repository 134 may be provided by a single physical machine, multiple computer systems, one or more virtual machines, a grid, one or more databases, one or more filesystems, and/or a cloud computing system. Analysis apparatus 202, filtering apparatus 204, and management apparatus 206 may additionally be implemented together and/or separately by one or more hardware and/or software components and/or layers.

Second, company features 224, recruiting features 226, learning culture features 228, engagement features 230, and profile features 232 may be obtained from a number of data sources. For example, data repository 134 may include data from a cloud-based data source such as a Hadoop Distributed File System (HDFS) that provides regular (e.g., hourly) updates to data associated with connections, people searches, recruiting activity, and/or profile views. Data repository 134 may also include data from an offline data source such as a Structured Query Language (SQL) database, which refreshes at a lower rate (e.g., daily) and provides data associated with profile content (e.g., profile pictures, summaries, education and work history) and/or profile completeness. Data repository 134 may further include data from external systems, such as CRM and/or sales-management platforms.

Finally, various techniques may be used to produce weights, quality indicators 234, and/or other values associated with lead scores 242. For example, values of weights used to combine the quality indicators into the lead score may be determined based on business requirements, data coverage, and/or feedback from sales professionals. The weights may also, or instead, be calculated using one or more statistical models, formulas, and/or rules that assess the relative importance of individual quality indicators to outcomes associated with engaging the sales leads. Similarly, quality indicators 234 may be calculated from weighted combinations of company features 224, recruiting features 226, learning culture features 228, and/or engagement features 230; by applying statistical models to the features; and/or by applying equations, formulas, or rules to the features. Moreover, the filters, features, quality indicators 234, and/or other components used to produce the lead scores may be adapted to other types of products offered by or within the online professional network, including, but not limited to, recruiting, advertising, marketing, and/or sales solutions.

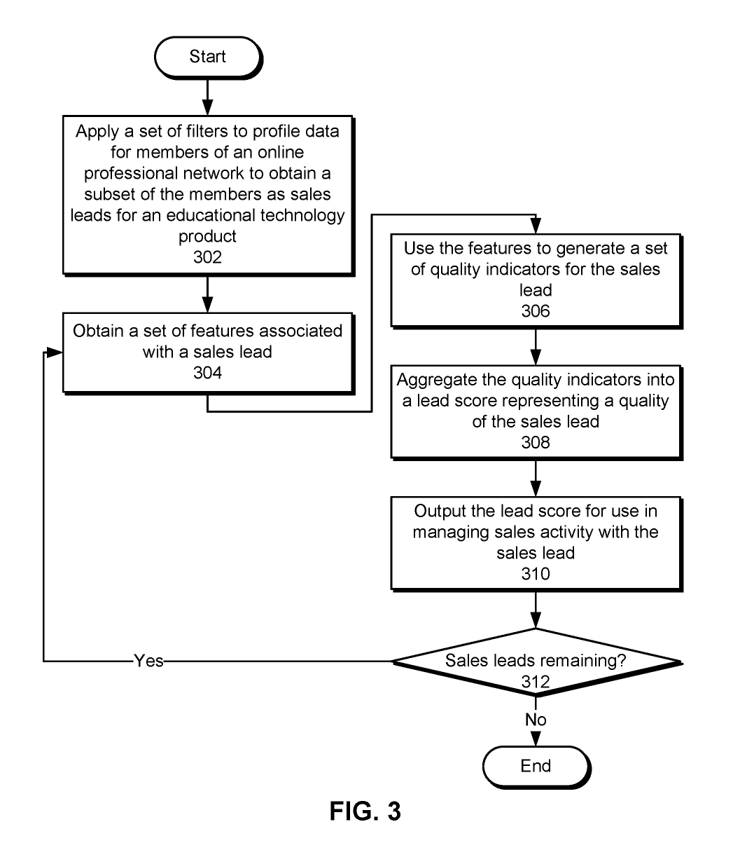

FIG. 3 shows a flowchart illustrating the processing of data in accordance with the disclosed embodiments. More specifically, FIG. 3 shows a flowchart of automatically prioritizing sales leads for an educational technology product. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of sales leads is identified in a set of members of an online professional network. More specifically, a set of filters is applied to profile data for the members to obtain a subset of the members as sales leads for an educational technology product (operation 302). The filters may include a market segment (e.g., members who have previously expressed interest in the educational technology product), employment status (e.g., employed or unemployed), student status (e.g., student or non-student), employer (e.g., a company that does not make the educational technology product), and/or company size (e.g., companies with more than 10 employees).

Next, a set of features associated with a sales lead is obtained (operation 304). The features may include profile data for the sales lead, as well as one or more company features, recruiting features, learning culture features, and/or engagement features associated with the sales lead and/or the company at which the sales lead is employed.

The features are then used to generate a set of quality indicators for the sales lead (operation 306). For example, various subsets of features may be used to produce member-level indicators such as a learning and development indicator, prospect score, email domain indicator, and/or contact information indicator. The features may also be used to generate company-level indicators such as a separate learning and development indicator, customer ranking, potential spending, and/or predicted purchase behavior. One or more of the quality indicators may be obtained as output from a statistical model, after one or more of the features are inputted into the statistical model.

The quality indicators are then aggregated into a lead score representing the quality of the sales lead (operation 308). For example, the quality indicators may be normalized to fall within specific numeric ranges, and the normalized quality indicators may be combined with a set of weights to produce the lead score. Each weight may represent the relative importance of the corresponding quality indicator in producing the lead score.

Finally, the lead score is outputted for use in managing sales activity with the sales lead (operation 310). For example, the lead score may be displayed with the quality indicators, features, and/or other attributes associated with the sales lead. Operations 304-310 may be repeated for remaining sales leads 312 for the educational technology product. In turn, lead scores for the sales leads may be used to prioritize engagement with the sales leads and/or perform or other sales or marketing activities involving the sales leads.

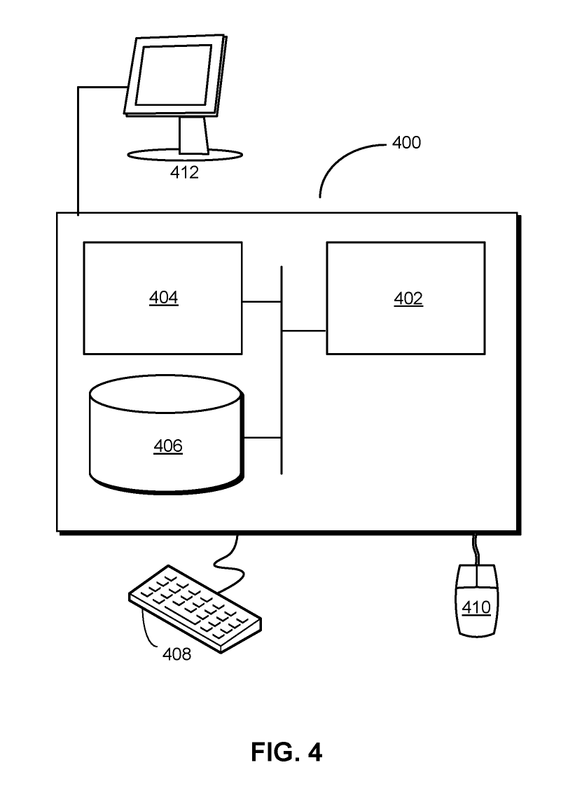

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system may include an analysis apparatus and a management apparatus, one or both of which may alternatively be termed or implemented as a module, mechanism, or other type of system component. The analysis apparatus may obtain a set of features associated with a sales lead for an educational technology product. Next, the analysis apparatus may use the set of features to generate a set of quality indicators for the sales lead. The analysis apparatus may then aggregate the quality indicators into a lead score representing a quality of the sales lead. Finally, the management apparatus may output the lead score for use in managing sales activity with the sales lead.

In addition, one or more components of computer system 400 may be remotely located and connected to the other components over a network. Portions of the present embodiments (e.g., analysis apparatus, management apparatus, filtering apparatus, data repository, etc.) may also be located on different nodes of a distributed system that implements the embodiments. For example, the present embodiments may be implemented using a cloud computing system that automatically evaluates and prioritizes a set of remote sales leads for an educational technology product.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of features associated with a sales lead for an educational technology product, wherein the set of features comprises profile data from an online professional network;
using the set of features to generate, by one or more computer systems, a set of quality indicators for the sales lead;
aggregating, by the one or more computer systems, the quality indicators into a lead score representing a quality of the sales lead; and
outputting the lead score for use in managing sales activity with the sales lead.

2. The method of claim 1, further comprising:
using one or more of the features to identify the sales lead in a set of members of the online professional network.

3. The method of claim 2, wherein using the one or more of the features to identify the sales lead comprises:
applying a set of filters to the profile data for the members to obtain a subset of the members as sales leads for the educational technology product.

4. The method of claim 3, wherein the set of filters comprises at least one of:
a market segment;
an employment status;
a student status;
an employer; and
a company size.

5. The method of claim 1, wherein the set of quality indicators comprises:
one or more member-level indicators; and
one or more company-level indicators.

6. The method of claim 5, wherein the one or more member-level indicators include at least one of:
a learning and development indicator;
a prospect score;
an email domain indicator; and
a contact information indicator.

7. The method of claim 5, wherein the one or more company-level indicators include at least one of:
a learning and development indicator;
a customer ranking;
a potential spending; and
a predicted purchase behavior.

8. The method of claim 1, wherein using the set of features to generate the set of quality indicators for the sales lead comprises:
inputting one or more of the features into a statistical model; and
using the statistical model to produce one or more of the quality indicators.

9. The method of claim 1, wherein aggregating the quality indicators into the lead score comprises:
normalizing the quality indicators; and
combining the normalized quality indicators with a set of weights to produce the lead score.

10. The method of claim 1, wherein the set of features further comprises at least one of:
a company feature;
a recruiting feature;
a learning culture feature; and
an engagement feature.

11. An apparatus, comprising:
one or more processors; and
memory storing instructions that, when executed by the one or more processors, cause the apparatus to:
obtain a set of features associated with a sales lead for an educational technology product, wherein the set of features comprises profile data from an online professional network;
use the set of features to generate a set of quality indicators for the sales lead;
aggregate the quality indicators into a lead score representing a quality of the sales lead; and
output the lead score for use in managing sales activity with the sales lead.

12. The apparatus of claim 11, wherein the memory further stores instructions that, when executed by the one or more processors, cause the apparatus to:
use one or more of the features to identify the sales lead in a set of members of the online professional network.

13. The apparatus of claim 12, wherein using the one or more of the features to identify the sales lead comprises:
applying a set of filters to the profile data for the members to obtain a subset of the members as sales leads for the educational technology product.

14. The apparatus of claim 13, wherein the set of filters comprises at least one of:
a market segment;
an employment status;
a student status;
an employer; and
a company size.

15. The apparatus of claim 11, wherein the set of quality indicators comprises:
one or more member-level indicators; and
one or more company-level indicators.

16. The apparatus of claim 15, wherein the one or more member-level indicators include at least one of:
a learning and development indicator;
a prospect score;
an email domain indicator; and
a contact information indicator.

17. The apparatus of claim 15, wherein the one or more company-level indicators include at least one of:
a learning and development indicator;
a customer ranking;
a potential spending; and
a predicted purchase behavior.

18. The apparatus of claim 11, wherein aggregating the quality indicators into the lead score comprises:
normalizing the quality indicators; and
combining the normalized quality indicators with a set of weights to produce the lead score.

19. A system, comprising:
an analysis module comprising a non-transitory computer-readable medium storing instructions that, when executed, cause the system to:
obtain a set of features associated with a sales lead for an educational technology product, wherein the set of features comprises profile data from an online professional network;
use the set of features to generate a set of quality indicators for the sales lead; and
aggregate the quality indicators into a lead score representing a quality of the sales lead; and
a management module comprising a non-transitory computer-readable medium storing instructions that, when executed, cause the system to output the lead score for use in managing sales activity with the sales lead.

20. The system of claim 19, wherein the set of quality indicators comprises:
one or more member-level indicators; and
one or more company-level indicators.
